(19) United States
(12) Patent Application Publication
(10) Pub. No.: US 2026/0191626 A1
(43) Pub. Date: Jul. 9, 2026

(54) DENTAL IMPLANTATION ASSESSMENT METHOD FOR IMPLANT DENTISTRY

(71) Applicant: STAR GENERATION LIMITED, New Taipei City (TW)

(72) Inventors: Chun-Leon CHEN, Taipei City (TW); Nina CHEN, Las Vegas, NV (US); Audree CHEN, Las Vegas, NV (US); Nicholas CHEN, Las Vegas, NV (US); Alec CHEN, Las Vegas, NV (US); Nolan CHEN, Las Vegas, NV (US)

(73) Assignee: STAR GENERATION LIMITED, New Taipei City (TW)

(21) Appl. No.: 19/555,347

(22) Filed: Mar. 3, 2026

Related U.S. Application Data
(63) Continuation-in-part of application No. 18/093,135, filed on Jan. 4, 2023, now abandoned.

(30) Foreign Application Priority Data
Jan. 5, 2022 (TW) 111100482

(51) Int. Cl. A61C 9/00; A61C 8/00; A61C 13/34

(52) U.S. Cl. CPC A61C 9/0046; A61C 8/0098; A61C 13/34

(57) ABSTRACT

A dental implantation assessment method includes the steps of creating a digital oral model with a health status table; constructing a reference line and an implantation space model on the digital oral model; dividing the implantation space model into multiple layers, and the layers is defined a center area and multiple analyzing areas with a plurality of assessment zones; selecting a digital dental implant to place into the implantation space model, and defining one test zone in each analyzing areas that contacts with a periphery of the digital dental implant as a selected zone; and comparing objective density data of the selected zones to determine assessment values, and an object type of the digital dental implant is determined according to a sum of the assessment values. A dentist can decide an optimal dental implant through digital dental implant size selection and implantation simulation to ensure successful dental implant surgery.

### CROSS-REFERENCE TO RELATED APPLICATIONS

This application is a continuation-in-part of U.S. patent application no. 18/093,135, filed on January 4, 2023, which claims priority to Taiwanese Patent Application 111100482 filed in the Taiwanese Patent Office on January 5, 2022, the entire contents of which is being incorporated herein by reference.

### FIELD OF THE INVENTION

The present invention relates to a dental implantation assessment method for checking whether a patient is allowed for immediate implant placement, and more particularly, to a dental implantation assessment method, in which an implantation space model is created in advance to simulate the connecting state between a digital dental implant and an alveolar bone model.

### BACKGROUND OF THE INVENTION

A person having one or more missing teeth owing to tooth decay, lesion or injury would often have problems in speaking, eating and good facial appearance. In this case, the manufacture of dentures for the position of a missing tooth is necessary. Currently, dental implants have gradually replaced the conventional dentures. In a dental implant surgery, a titanium artificial tooth root is implanted into a patient’s alveolar bone to replace the damaged or missing tooth. It usually requires 3 to 6 months to get good osseointegration of dental implant. Thereafter, an artificial crown can be mounted on the dental implant to restore good facial appearance and chewing function.

While the dental implantation has become the main way of treating missing teeth, there are still risks of a failed dental implant surgery. There are many factors leading to a failed dental implant surgery, such as post-operative infection, bad occlusion habit, poor oral hygiene, poor implant design, etc. The problem of poor implant design is mainly attributable to the insufficient dentist experience that leads to incorrect selection of implant size, implant placement angle, implant placement direction, or implant placement position. Other problems attributable to inexperience dentist include wrong material for guided bone regeneration and incomplete wound treatment.

Among others, pre-surgery planning and good tooth treatment aiding appliances are important to reduce the risk of a failed dental implantation. In the conventional pre-surgery planning, radiography using X-ray is mainly used to get the patient’s full-mouth X-ray film, based on which the dentist plans a general position for the dental implant and decides the desired implant placement direction and dental surgical guides on the patient’s teeth model.

Following the constantly improved technologies, computed tomography (CT) scanning and simulating software can be now used to assist the dental in obtaining a three-dimensional (3D) teeth model that allows the dentist to observe from all directions. However, while the observation of the 3D teeth model image can help the dentist make his pre-surgical plan, there is not any software or application program presently available for assisting the dentist in judging whether a location of a missing tooth is allowed for implantation or which type of implant should be used at the location of a missing tooth to obtain the optimal dental implantation.

### SUMMARY OF THE INVENTION

A primary object of the present invention is to provide an assessment method for assisting a dentist in determining whether a dental implant can be used in an immediate implant placement and be firmly located in a patient’s alveolar bone. According to the assessment method, the dentist first gets a patient’s digital oral model through computed tomography (CT) scan of the patient’s oral areas and simulates the connecting state between a digital dental implant and the patient’s alveolar bone modal by electronic device, so as to verify an object type of the digital dental implant.

Another object of the present invention is to provide the above assessment method, in which, when more than one digital dental implant is selected by the dentist, the selected digital dental implants are analyzed based on the object types thereof to generate a suggested option to the dentist, enabling the dentist to easily determine a physical dental implant suitable for use in an immediate implant placement surgery.

A further object of the present invention is to provide the above assessment method, in which the object type of the digital dental implant can be assessed according to a total number of zones having a valid value or a total number of zones having a required forcing strength. The digital dental implant and its assessed object type are shown at the same time.

To achieve the above and other objects, the present invention provides a dental implantation assessment method for implant dentistry. In first embodiment, the method comprises a digital model creation step, a position determination step, a table creation step, a space forming step, a table-space combination step, an implantation simulation step, and a result generation step.

In the digital model creation step, a digital oral model having a three-dimensional (3D) appearance is created by scanning a patient’s oral using X-ray computed tomography (CT). In the position determination step, an implant placement position is determined on the digital oral model and a reference line passing a centric occlusion is set up at the implant placement position. In the table creation step, an alveolar bone area on the digital oral model located around the reference line is determined on the electronic device and a health status table is generated by electronic device based on the alveolar bone area.

In the space forming step, an implantation space model is formed at the implant placement position around the reference line, such that the alveolar bone area is encircled by the implantation space model. The implantation space model internally defines a plurality of levels, each of the levels including a center area and a plurality of analyzing areas located immediately around the center area.

In the table-space combination step, every analyzing area is divided into a plurality of assessment zones, which are combined with the density data of health status table; an assessment value of the assessment zones are calculated by the electronic device according to the health status table. In the implantation simulation step, a digital dental implant is selected for placement into the implantation space model, such that the center area of the levels overlap the digital dental implant and one of the assessment zones in every analyzing area adjacent to an outer peripheral surface of the digital dental implant is defined as a selected zone. In the result generation step, a computation is made on every selected zone to derive a sum value of the assessment values for determining an object type of the digital dental implant; and the object type can be one of a suitable object type allowed for use in immediate implant placement and an unsuitable object type failing to provide stable and firm fixing ability.

The assessment method also includes a further simulation and assessment step and an option suggesting step. In the further simulation and assessment step, a replacement digital dental implant is used in place of the digital dental implant. The replacement digital dental implant is different from the digital dental implant in size and has a replacement outer peripheral surface. The assessment zones on every analyzing area adjacent to the replacement outer peripheral surface are defined as replacement selected zones, according to which an object type of the replacement digital dental implant is determined.

In the option suggesting step, a comparison is made between the object type of the digital dental implant and the replacement digital dental implant to generate a suggested option. In the case the digital dental implant and the replacement digital dental implant all are determined as a suitable object, one of the suitable objects having a higher sum value of the assessment values is selected as the suggested option for use in the dental implant surgery; and in the case one of the digital dental implant and the replacement digital dental implant is determined as a suitable object while the other one is an unsuitable object, the one being the suitable object is selected as the suggested option for use in the dental implant surgery.

In the case both the digital dental implant and the replacement digital dental implant are determined as unsuitable objects, the suggested option includes an assessment result that no dental implant surgery can be performed and a re-simulation option that a re-simulation and assessment step is to be performed. In the re-simulation and assessment step of the assessment method, a further replacement digital dental implant is used in place of the replacement digital dental implant. The further replacement digital dental implant is different from the replacement digital dental implant in size and has a further replacement outer peripheral surface; one of the assessment zones on every analyzing area adjacent to the further replacement outer peripheral surface are defined as a further replacement selected zone, so that an object type of the further replacement digital dental implant is determined based on the further replacement selected zone of every analyzing area.

The implantation space model has a cross-sectional diameter that is limited by one of the following two measures: a distance between two teeth located immediately at two lateral sides of the implant placement position, and a width of gum of the digital oral model. And, the digital dental implant has an implant diameter and an implant length; the implant diameter limited by an area size of the implantation space model, and the implant length is limited by the number of levels of the implantation space model.

In the space forming step, a height location of the implantation space model is determined according to a top 3D configuration of the alveolar bone area. The top 3D configuration defines a slanted reference surface, the slanted reference surface angularly intersects the reference line and the implantation space model has a top surface that passes an intersection of the slanted reference line and the reference line, such that the alveolar bone area is encircled by more than one half of the analyzing areas in the uppermost level of the implantation space model.

Further, in the space forming step, a tilting direction of the implantation space model is determined according to the health status of the alveolar bone area; and the implantation space model has a centerline that is inclined relative to the reference line, such that a plurality of contact volumes of the implantation space model with the alveolar bone area are changed to different positions.

The health status table has a plurality of density data for listing in different regions of the alveolar bone area, such that each of the assessment values in the corresponding assessment zone is decided to one of a valid value representing a healthy state and an invalid value representing an unhealthy state.

The health status table has a plurality of density data for listing in different regions of the alveolar bone area, such that each of the assessment values is generated according to the density data and represents a forcing strength acting between the digital dental implant and the alveolar bone area.

In second embodiment, the dental implantation assessment method of present invention comprises a digital model creation step, a position determination step, a space dividing step, an implantation simulation step, and a result generation step.

In the digital model creation step, a computed tomography (CT) device is used to scan a patient’s oral areas to construct a digital oral model and a model database, the digital oral model includes a plurality of tooth models and an alveolar bone model, the model database stores a plurality of position data and a plurality of density data as a healthy status table, and the position data and the density data match each position of the alveolar bone model.

In the position determination step, an electronic device receives the digital oral model to display the tooth models and the alveolar bone model, the electronic device selects an objective tooth of the tooth models to construct a reference line matching a centric occlusion of the objective tooth, and constructs an implantation space model based on the reference line to encircle the alveolar bone model.

In the space dividing step, in which the electronic device divides the implantation space model into a plurality of layers, the layers include a center area and a plurality of analyzing areas located immediately around the center area, and the analyzing areas are divided into a plurality of assessment zones.

In the implantation simulation step, the electronic device selects a digital dental implant to place in the implantation space model, such that the digital dental implant overlaps the center area of layers, and one of the assessment zones adjacent to an outer peripheral surface of the digital dental implant is defined as a selected zone; and

In the result generation step, in which the electronic device receives a plurality of objective density data matching the selected zone of the analyzing areas from the model database, and compares each objective density data with a density threshold value to determine an assessment value of the selected zone; the electronic device compares a sum of the assessment values with a threshold value to determine an object type of the digital dental implant, the digital dental implant being determined as a suitable object allowed for use in immediate implant placement when the sum is larger than the threshold value; and the digital dental implant being determined as an unsuitable object failing to provide stable and firm fixing ability when the sum is smaller than the threshold value .

The dental implantation assessment method also comprises a further simulation and assessment step and an option suggesting step. In the further simulation and assessment step, a replacement digital dental implant is used on the electronic device in place of the digital dental implant; the replacement digital dental implant being different from the digital dental implant in size and having a replacement outer peripheral surface; one of the assessment zones adjacent to the replacement outer peripheral surface is defined by the electronic device as a replacement selected zone, and the electronic device determines an object type of the replacement digital dental implant according to the replacement selected zone on the analyzing areas.

In the option suggesting step, the electronic device compares the object type between the digital dental implant and the replacement digital dental implant to generate a suggested option. when the digital dental implant and the replacement digital dental implant are determined as suitable objects, one of the suitable objects having a higher sum of the assessment values is selected as the suggested option for use in the dental implant surgery; and when one of the digital dental implant and the replacement digital dental implant is determined as a suitable object while the other one is an unsuitable object, the electronic device selects the suitable object as the suggested option. when both of the digital dental implant and the replacement digital dental implant are determined as unsuitable objects, the electronic device generates an assessment result that no dental implant surgery can be performed, and suggests a re-simulation and assessment step as the suggested option.

In the re-simulation and assessment step, a further replacement digital dental implant is used on the electronic device in place of the replacement digital dental implant; the further replacement digital dental implant being different from the replacement digital dental implant in size and having a further replacement outer peripheral surface; one of the assessment zones adjacent to the further replacement outer peripheral surface is defined by the electronic device as a further replacement selected zone, so that the electronic device determines an object type of the further replacement digital dental implant according to the further replacement selected zone on the analyzing areas.

In one embodiment, a diameter of the implantation space model is smaller than a width of the alveolar bone model; in another embodiment, a diameter of the implantation space model is smaller than a distance between two teeth located immediately at two lateral sides.

Otherwise, an implant diameter of the digital dental implant is limited by the diameter of the implantation space model, and an implant length of the digital dental implant is limited by a layer number of the implantation space mode.

The assessment method of the present invention is characterized in that a CT scan is performed to obtain the density of the alveolar bone model, so that the density at different locations of the alveolar bone model can be organized into the health status table, based on which the connecting state between the digital dental implant and the alveolar bone model can be simulated. Therefore, the dentist can select in the pre-surgery planning the optimal dental implant for use and reduce the chance of failure in a dental implant surgery.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in the dental implantation assessment method according to a first preferred embodiment of the present invention;

FIGS. 2A and 2B pictorially show a digital model creation step in the method of FIG. 1;

FIG. 3 pictorially shows a position determination step in the method of FIG. 1;

FIG. 4 pictorially shows a table creation step in the method of FIG. 1;

FIG. 5 pictorially shows a space forming step in the method of FIG. 1;

FIG. 6 is a schematic view of an implantation space model formed in the present invention;

FIG. 7 pictorially shows the forming of an implantation space model based on a slanted reference surface of an alveolar bone area;

FIG. 8 shows an implantation space model being inclined relative to a reference line of an implant placement position;

FIG. 9 pictorially shows a table-space combination step in the method of FIG. 1;

FIGS. 10A and 10B pictorially show an implantation simulation step in the method of FIG. 1;

FIGS. 11A to 11C pictorially show a result generation step in the method of FIG. 1;

FIGS. 12A and 12B are mimic diagrams of different alveolar bone conditions;

FIG. 13 is a flowchart showing the steps included in the dental implantation assessment method according to a second preferred embodiment of the present invention;

FIGS. 14A to 14C pictorially show a further simulation and assessment step in the method of FIG. 13;

FIGS. 15A to 15C pictorially show an option suggesting step in the method of FIG. 13;

FIG. 16 pictorially shows a re-simulation and assessment step in the method of FIG. 13;

FIG. 17 is a flowchart showing the steps included in the dental implantation assessment method according to a third preferred embodiment of the present invention; and

FIG. 18 pictorially shows a digital model creation step in the method of FIG. 17.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

The present invention provides a dental implantation assessment method for implant dentistry, such that a dentist in planning a dental implant surgery can use an assistance program installed on an electronic device to assist in assessing whether an implant can be placed immediately after a tooth extraction and in deciding an optimal implant size to ensure a high successful rate of the dental implant surgery.

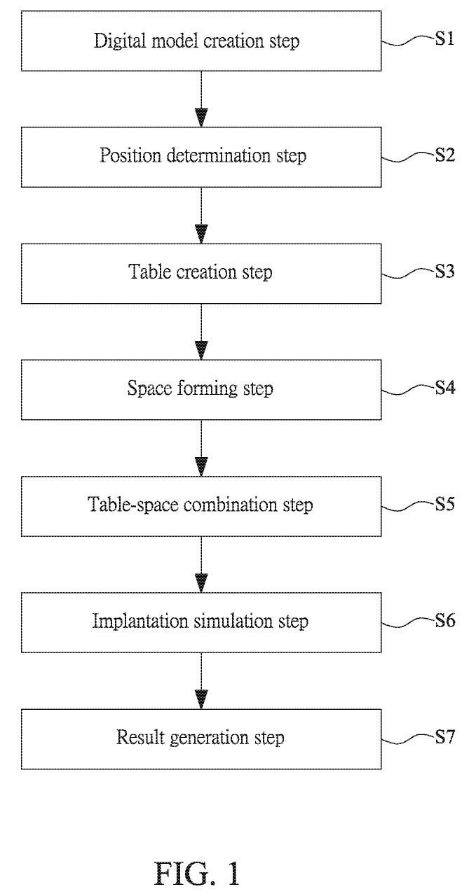

Please refer to FIG. 1. In a first preferred embodiment of the present invention, the dental implantation assessment method includes a digital model creation step S1, a position determination step S2, a table creation step S3, a space forming step S4, a table-space combination step S5, an implantation simulation step S6, and a result generation step S7.

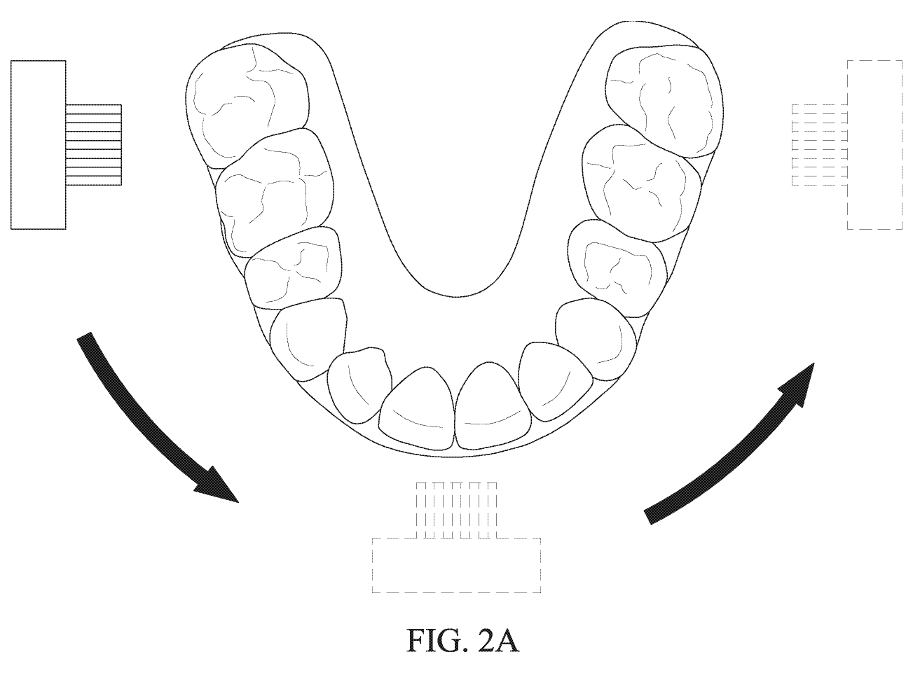

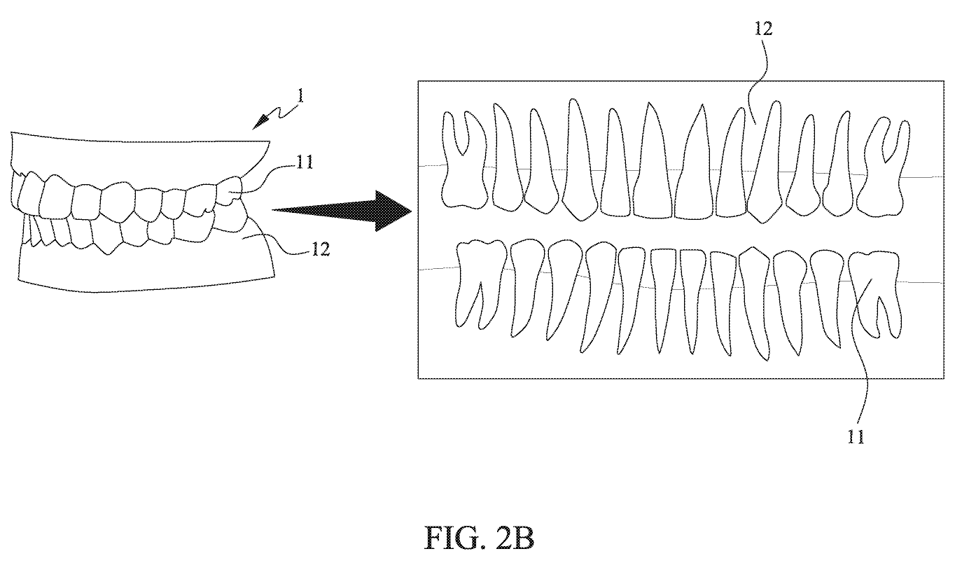

Please refer to FIGS. 2A and 2B. In the digital model creation step S1, a computed tomography (CT) device is used to scan a patient’s oral areas to construct a digital oral model 1. The digital oral model 1 includes a plurality of tooth models 11 and an alveolar bone model 12. The electronic device further receives a digital oral model 1 from the CT device. The digital oral model 1 can also be transformed by the electronic device into a planar image showing all teeth, as shown in FIG. 2B. In view that bone density of the patient’s alveolar bone is an important factor having an influence on successful implant placement, the digital oral model 1 shall present different colors according to different bone densities.

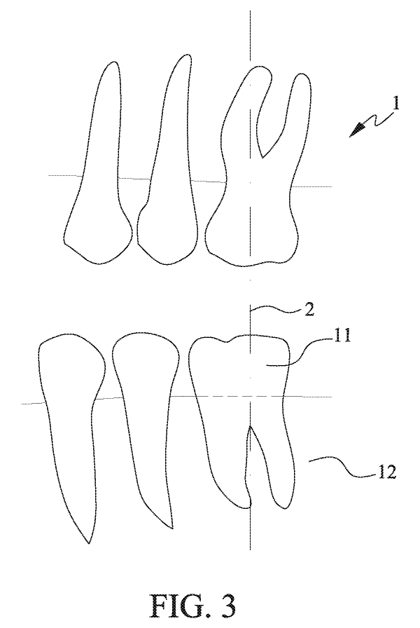

Please refer to FIG. 3. In the position determination step S2, the position of a damaged tooth is determined, so that an implant placement position on the digital oral model 1 can be selected by the dentist on the electronic device. Then, the electronic device shall set up a virtue reference line 2 that passes a center of the dental occlusion at the implant placement position.

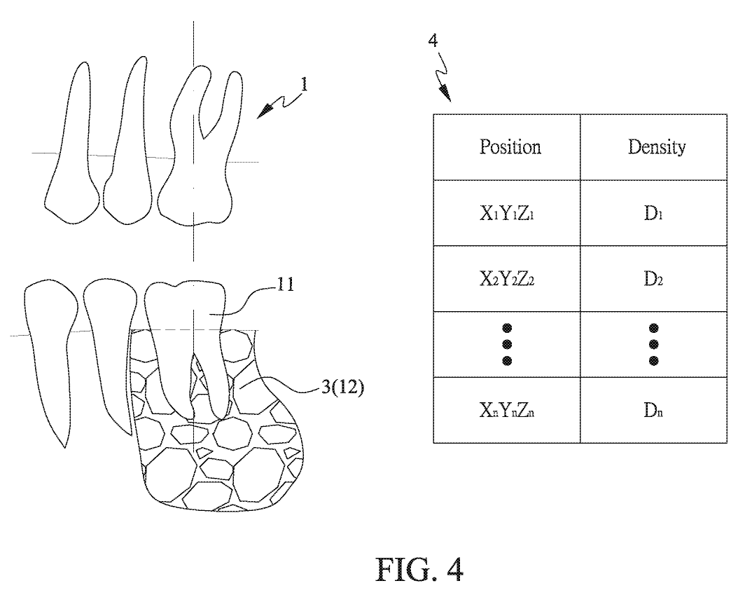

Please refer to FIG. 4. In the table creation step S3, an alveolar bone area 3 surrounding the root of the damaged tooth is determined based on the reference line 2 and the electronic device generates a health status table 4 according to the bone density of the alveolar bone area 3. As shown, the health status table 4 includes a position field, and a density field. In the position field, x-axis, y-axis and z-axis coordinates are used to define each of a plurality of region positions. The electronic device shall compute based on a color corresponding to the region position to obtain a density data (Hounsfield Unit), such that a plurality of position data and a plurality of density data are listed in the health status table 4.

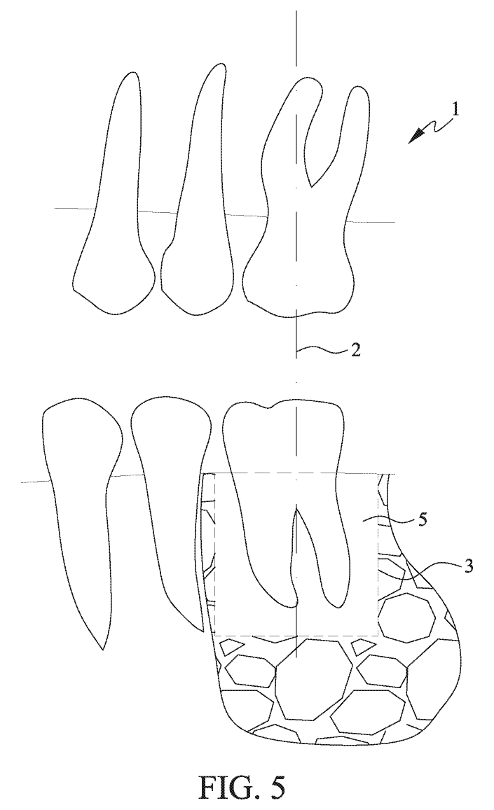

Please refer to FIG. 5. In the space forming step S4, an implantation space model 5 is formed. The implantation space model 5 has a center in alignment with the reference line 2, such that the root of the damaged tooth and the alveolar bone area 3 are encircled by the implantation space model 5.A height location of the implantation space model 5 is determined according to a top 3D configuration of the alveolar bone area 3, and the implantation space model 5 has a cross-sectional diameter that is limited by one of the following two measures: a distance between two teeth located immediately at two lateral sides of the implant placement position, and a width of gum of the alveolar bone model 12.

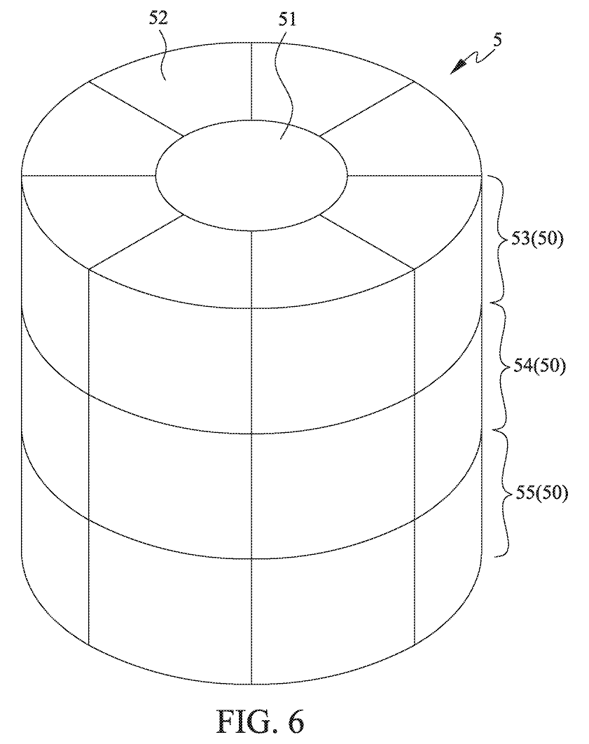

When the alveolar bone area 3 has an equal-height contour as shown in FIG. 5, the implantation space model 5 has a top flush with a reference surface of the alveolar bone area 3 and is then defined by the reference surface and the cross-sectional diameter to have a cylindrical shape, as shown in FIG. 6.

Please refer to FIG. 6. The implantation space model 5 internally defines a plurality of levels 50. Every level 50 includes a center area 51 and a plurality of analyzing areas 52 located immediately around the center area 51. The implantation space model 5 shown in FIG. 6 defines three levels, including an upper level 53, a middle level 54, and a lower level 55. The center area 51 of the three levels 53, 54, 55 are respectively defined as a round zone, and each of the round zones has eight sector-shaped analyzing areas 52 located immediately around it.

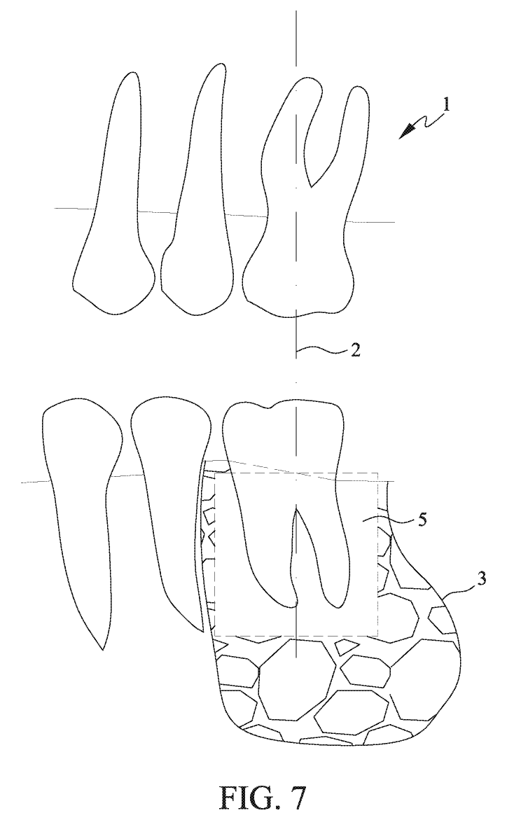

Please refer to FIG. 7. In another embodiment of the present invention, when the alveolar bone area 3 has a 3D configuration that is partially depressed, a slanted reference surface of the alveolar bone area 3 is defined based on the partially depressed 3D configuration, such that the slanted reference surface angularly intersects the reference line 2 and the implantation space model 5 shall have a top surface that passes an intersection of the slanted reference surface and the reference line 2. The implantation space model 5 is then defined by the top surface and the cross-sectional diameter, such that the alveolar bone area 3 is encircled by more than one half of the analyzing areas 52 in the uppermost level 50.

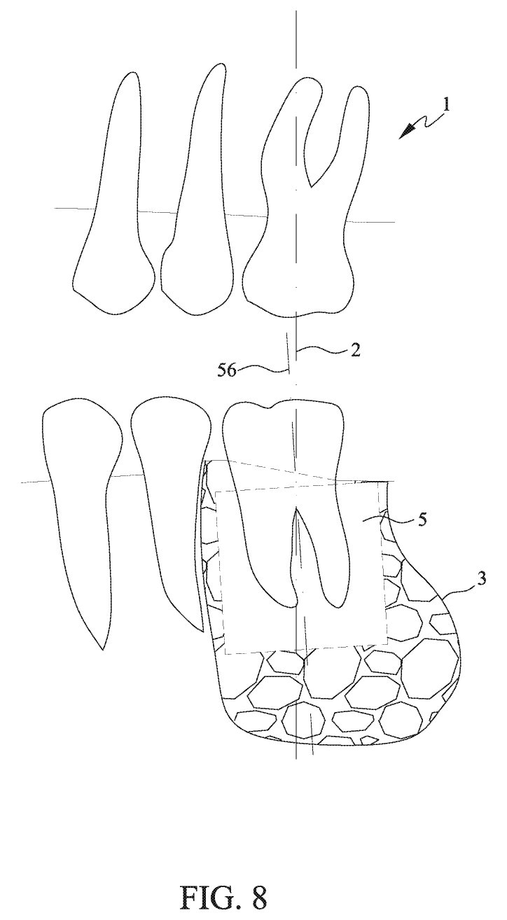

Please refer to FIG. 8. In the space forming step S4, a tilting direction of the implantation space model 5 is determined according to the health status of the alveolar bone area 3. That is, the implantation space model 5 may have a centerline 56 that is inclined relative to the reference line 2, such that the implantation space model 5 is slanted relative to the reference line 2 and has a top center located on the reference line 2. With this arrangement, it is able to change proportions of contact of the implantation space model 5 with the alveolar bone area 3 in different directions, such that the implantation space model 5 can contact with more volume of the alveolar bone area 3 that has relatively good bone density and contact with less volume of the alveolar bone area 3 that has relatively poor bone density. By changing the implantation space model 5 to different angular positions, it allows the dentist to simulate and consider more possible patterns to decide the optimal way of dental implantation and increase the chance of performing the dental implant surgery successfully.

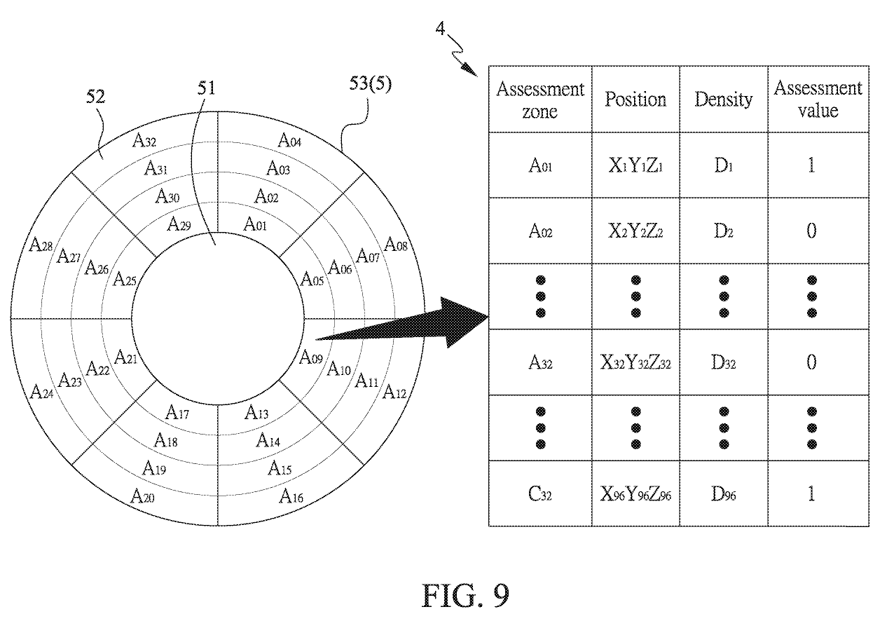

Please refer to FIG. 9. In the table-space combination step S5, every analyzing area 52 is divided into a plurality of assessment zones according to a radial distance between different zones of the analyzing area 52 and the reference line 2. The assessment zones are assigned to different fields in the health status table 4, such that an assessment value is generated to each assessment zone according to the density data corresponding to the assessment zone. Wherein, the assessment zones in the upper level 53, the middle level 54 and the lower level 55 are numbered and given a leading letter “A”, “B”, and “C”, respectively.

In the illustrated preferred embodiment, each of the analyzing areas 52 in the three different levels 50 is divided into four assessment zones, which are sequentially located at different radial distances from the center area 51. Therefore, all the assessment zones respectively have a specific spatial position and a set of corresponding position data and density data. The electronic device shall compute the density data of each assessment zone to derive an assessment value for the same. As shown, the eight analyzing areas 52 in the upper level 53 are divided into total 32 assessment zones, which respectively have an assessment value of [1] or [0]. Wherein, value [1] is a valid value indicating the bone in the corresponding assessment zone is in a healthy state, and value [0] is an invalid value indicating the bone in the corresponding assessment zone is in an unhealthy state.

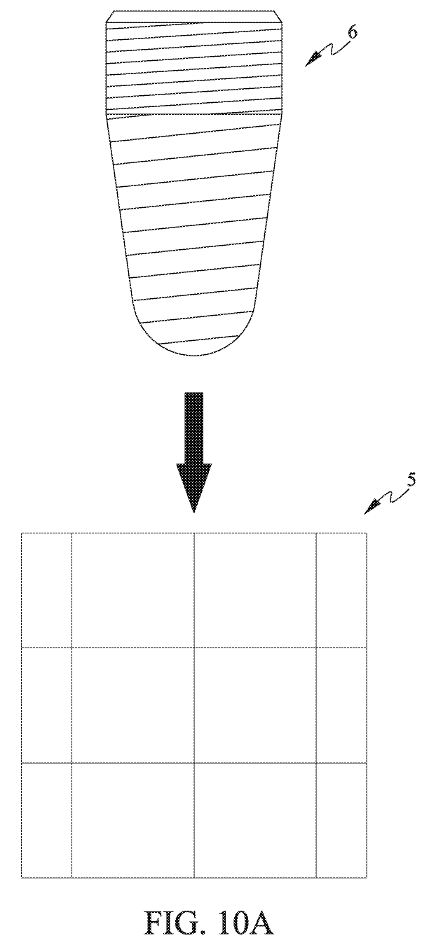

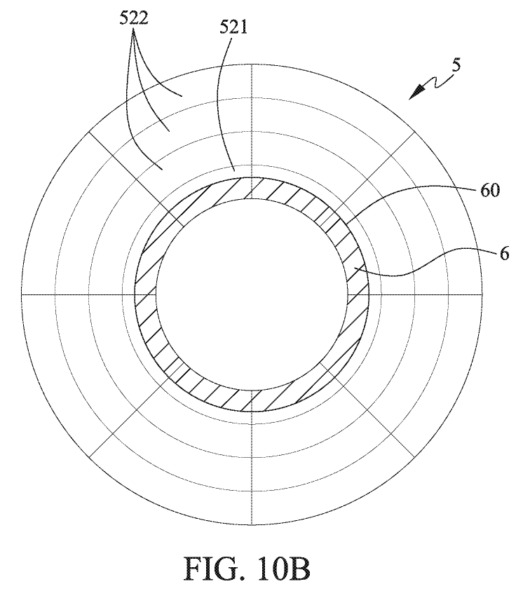

Please refer to FIG. 10A. In the implantation simulation step S6, the electronic device selects a digital dental implant 6 for placing into the implantation space model 5. The digital dental implant 6 is dimensionally larger than the center areas 51 to therefore overlap all the center areas 51 with an outer peripheral surface 60 of the digital dental implant 6 located outside the center areas 51. As shown in FIG. 10B, the outer peripheral surface 60 of the digital dental implant 6 is in contact with the eight radially innermost assessment zones. The innermost assessment zones on the analyzing areas 52 are defined as selected zones 521, while the remaining three radially outer assessment zones on each of the analyzing areas 52 are defined as non-selected zones 522.

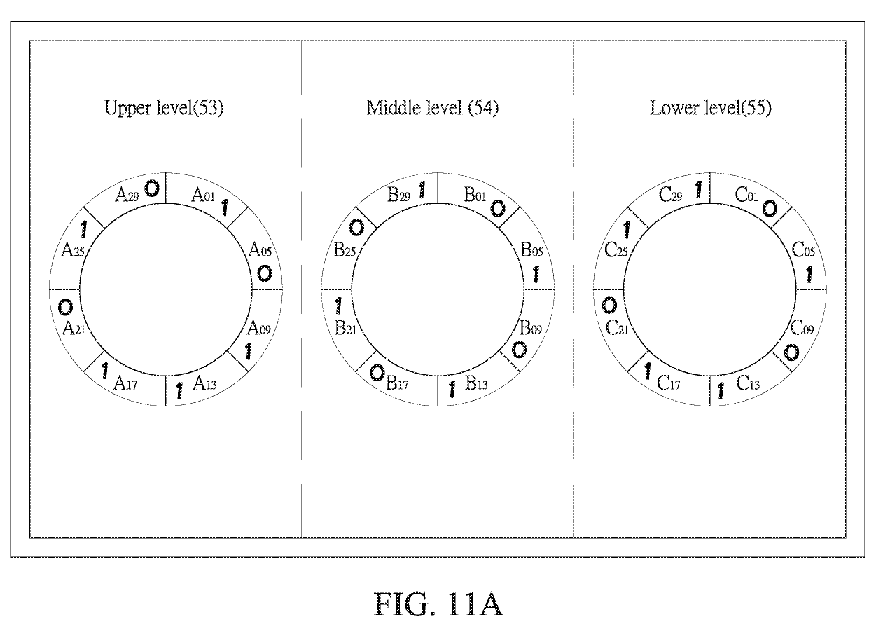

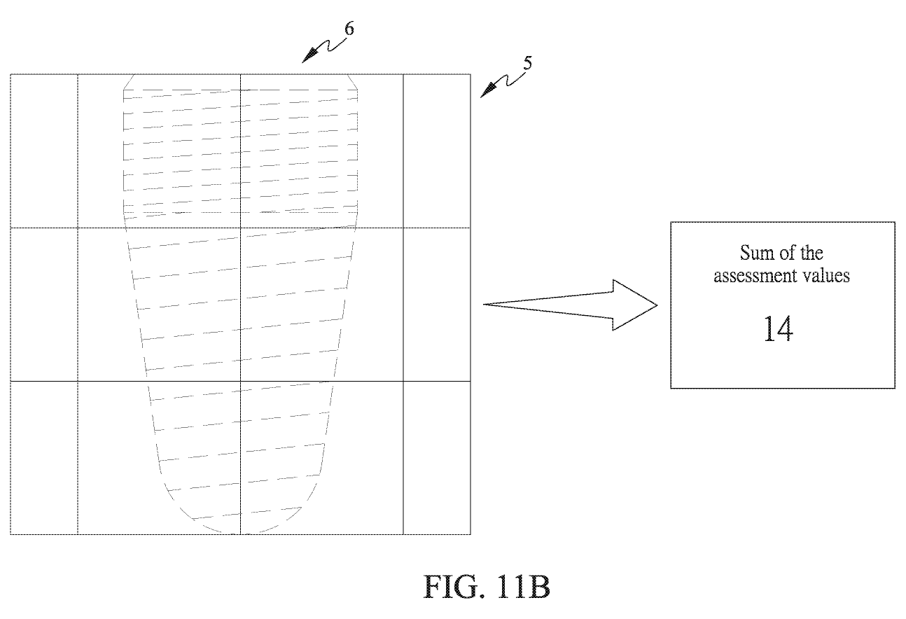

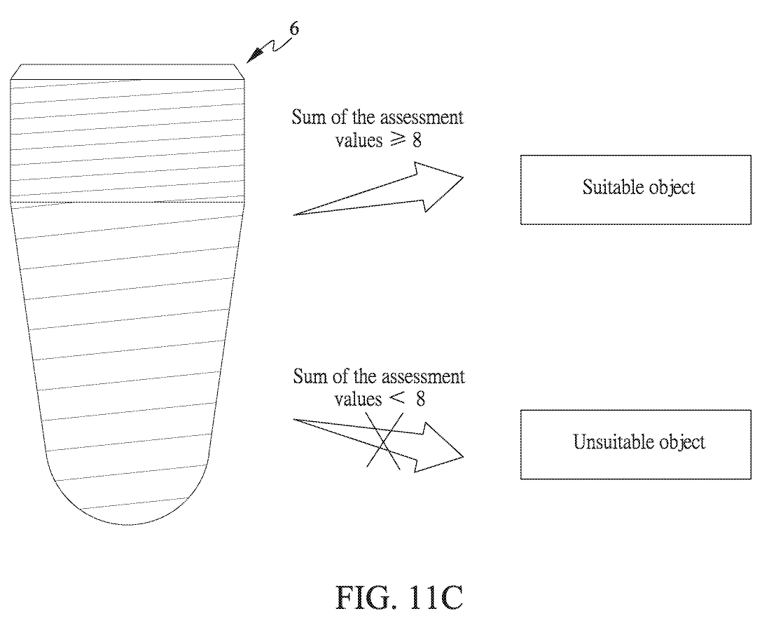

Please refer to FIG. 11A. In the result generation step S7, the selected zones 521 in the upper level 53, including the assessment zones A01, A05, A09, A13, A17, A21, A25 and A29, the selected zones 521 in the middle level 54, including the assessment zones B01, B05, B09, B13, B17, B21, B25 and B29, and the selected zones 521 in the lower level 55, including the assessment zones C01, C05, C09, C13, C17, C21, C25 and C29, are picked out and shown separately. As shown, among the selected zones 521, the assessment zones A01, A09, A13, A17, A25 in the upper level 53 respectively have a valid value [1], while other assessment zones A05, A21, A29 in the upper level 53 respectively have an invalid value [0]; the assessment zones B05, B13, B21, B29 in the middle level 54 respectively have a valid value [1], while other assessment zones B01, B09, B17, B25, B in the middle level 54 respectively have an invalid value [0]; and the assessment zones C05, C13, C17, C25, C29 in the lower level 55 respectively have a valid value [1], while other assessment zones C01, C09, C21 in the lower level 55 respectively have an invalid value [0].

Please refer to FIGS. 11B and 11C. The electronic device makes a computation on the assessment values of the selected zones 521 to derive a sum of the assessment values for determining an object type of the digital dental implant 6. The digital dental implant 6 and its object type will be shown on the electronic device at the same time. The digital dental implant 6 may be one of the following three object types, namely, a suitable object that can be used for immediate implant placement, an unsuitable object that fails to provide stable and firm fixing ability, and an optimal object that can be used for immediate implant placement.

When the sum of the assessment values is larger than or equal to one-third of a total number of the assessment zones, the digital dental implant 6 shall be determined as a suitable object. When the sum of the assessment values is smaller than one-third of the total number of the assessment zones, the digital dental implant 6 is determined as an unsuitable object. When the sum of the assessment values is larger than two-third of the total number of the assessment zones, the digital dental implant 6 is determined as an optimal object.

As shown in FIG. 11B, since the sum of the assessment values is 14, the digital dental implant 6 is determined as a suitable object, which allows the dentist to place a dental implant corresponding to the digital dental implant 6 in an extraction socket at the same time the damaged tooth is extracted. After the dental implantation, the patient needs to rest for a period of time to allow for good osseointegration between the dental implant and the patient’s alveolar bone, and a subsequent procedure of mounting an artificial crown can be performed only when the good osseointegration is achieved.

In operable embodiment, the density data can be an accurate density value. The electronic device calculates based on the density values to derive each of the assessment values, which would be an estimated forcing strength (not shown). The sum of the assessment values is defined as a force in newton for determining the object type of the digital dental implant 6. When the force is more than 20 newtons, the digital dental implant 6 is determined as a suitable object. On the other hand, when the force is less than 20 newtons, the digital dental implant 6 is determined as an unsuitable object (not shown).

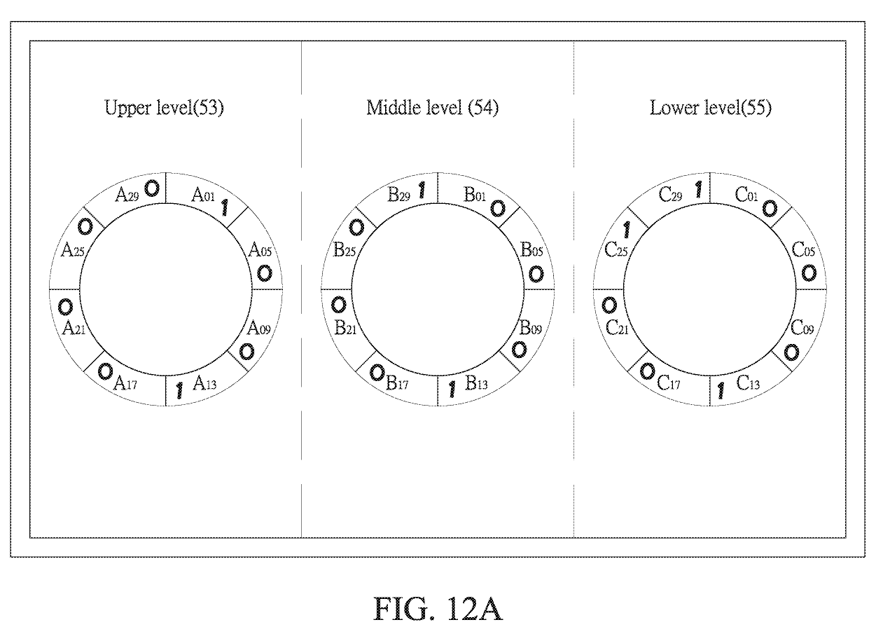

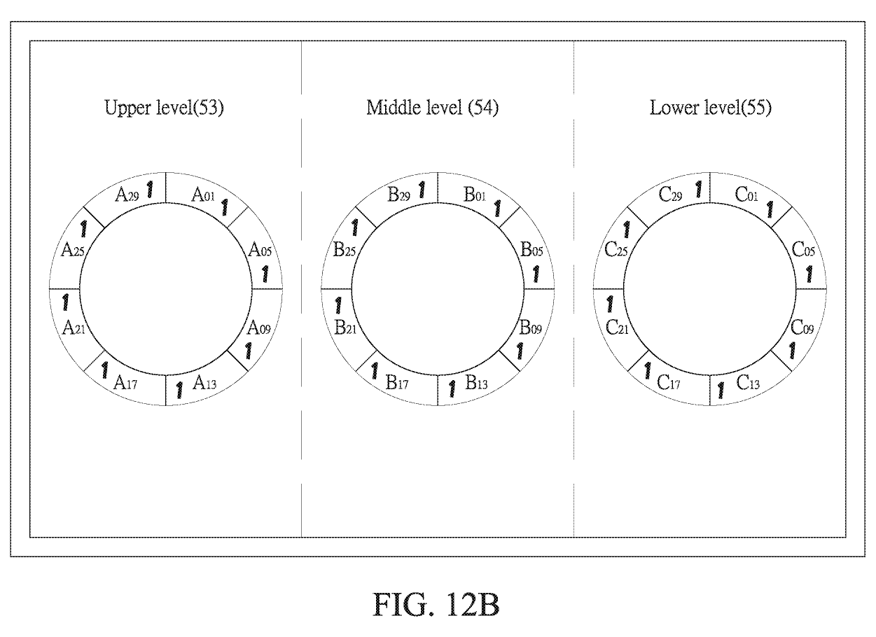

Please refer to FIGS. 12A and 12B, which show a digital dental implant 6 being an unsuitable object and an optimal object, respectively. As shown in FIG. 12A, only two assessment zones A01 and A13 in the upper level 53 of the digital dental implant 6 have the valid value [1], only two assessment zones B13 and B29 in the middle level 54 of the digital dental implant 6 have the valid value [1], and only three assessment zones C13, C25, C29 in the lower level 55 of the digital dental implant 6 have the valid value [1]. In this case, the one-third of the total number of the assessment zones is 8, and the sum of the assessment values is 7, which is smaller than the one-third of the total number of the assessment zones, i.e. smaller than 8. Therefore, the digital dental implant 6 in FIG. 12A is not suitable for immediate implant placement. In this case, a dental bone graft material must be filled in the extraction socket after the damaged tooth is extracted, so as to ensure good osseointegration later.

On the other hand, as shown in FIG. 12B, all the selected zones 521 in the upper, the middle and the lower level 53, 54, 55 of the digital dental implant 6 have the valid value of [1], and the sum of the assessment values is 24, which is larger than the two-third of the total number of the assessment zones, i.e. larger than 16, the digital dental implant 6 in FIG. 12B is therefore determined as an optimal object and a real dental implant corresponding thereto can be placed in the extraction socket immediately after the damaged tooth is extracted, and an artificial crown can be mounted to a top of the dental implant immediately after the implant placement.

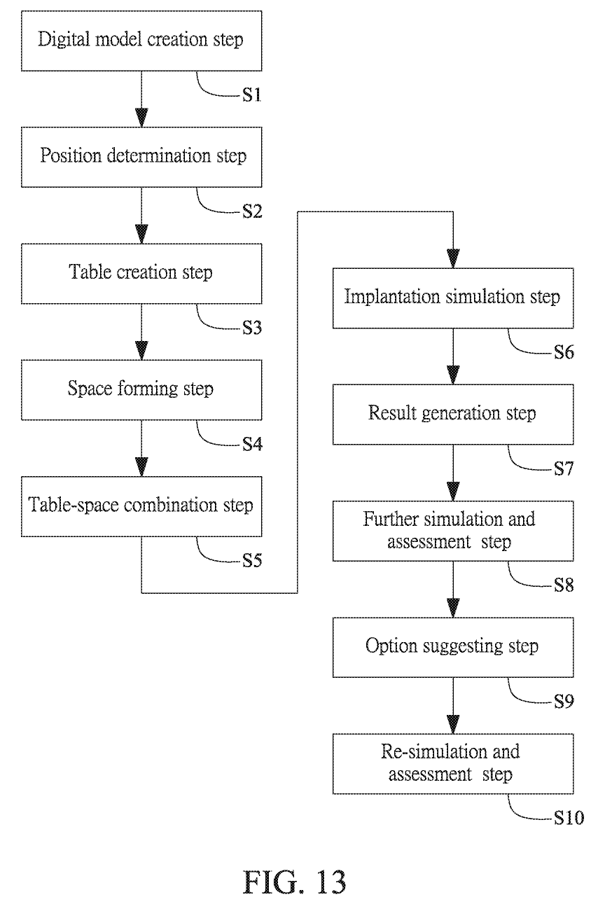

Please refer to FIG. 13. In a second preferred embodiment of the present invention, the dental implantation assessment method includes a digital model creation step S1, a position determination step S2, a table creation step S3, a space forming step S4, a table-space combination step S5, an implantation simulation step S6, a result generation step S7, a further simulation and assessment step S8, an option suggesting step S9, and a re-simulation and assessment step S10. Since the steps S1 to S7 in the second preferred embodiment are identical to those in the first preferred embodiment, they are not repeatedly described herein.

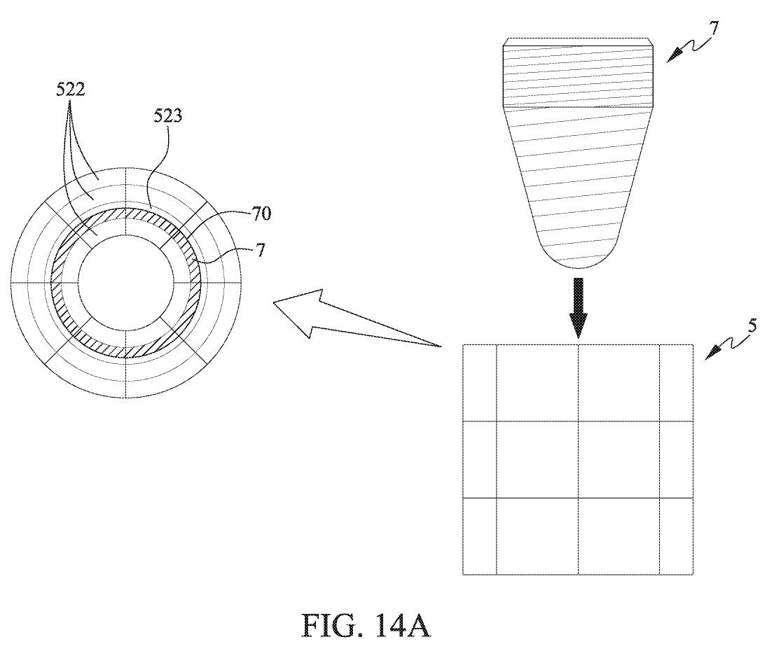

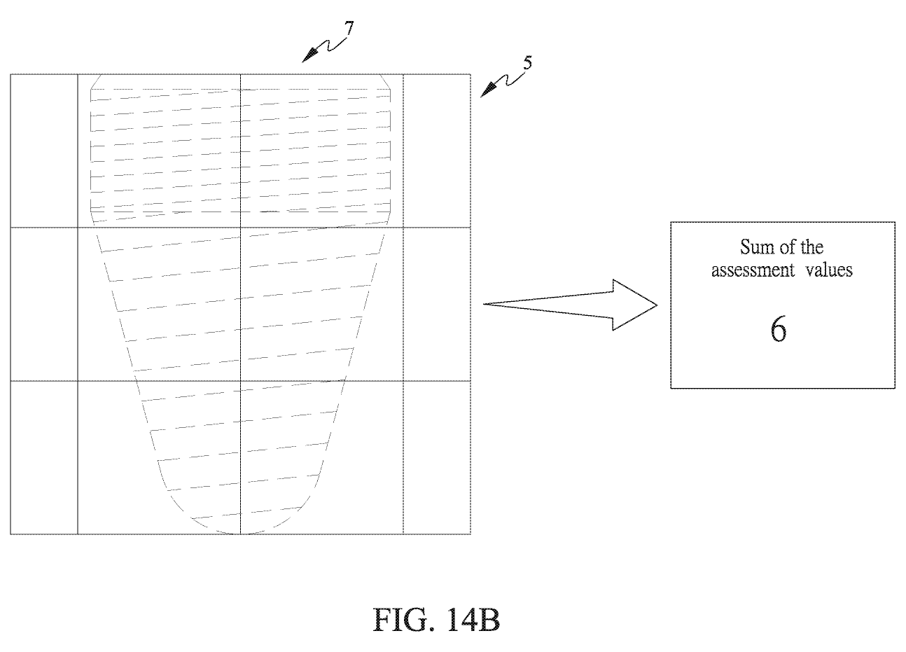

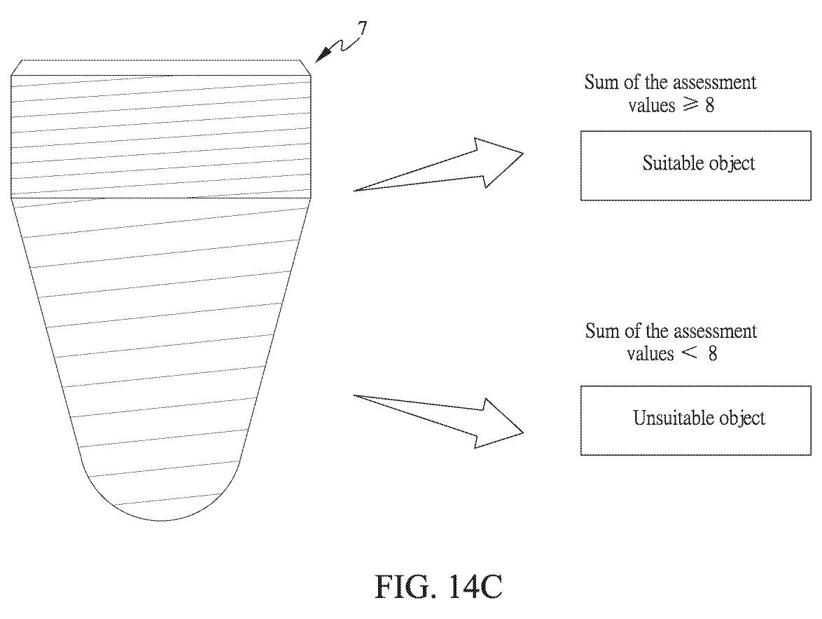

Please refer to FIG. 14A. In the further simulation and assessment step S8, a replacement digital dental implant 7 is used in place of the digital dental implant 6. The replacement digital dental implant 7 is dimensionally larger than the digital dental implant 6 and has a replacement outer peripheral surface 70, which is in contact with the analyzing areas 52 to define a plurality of replacement selected zones 523 thereon. As shown, the replacement outer peripheral surface 70 defines total 24 replacement selected zones 523, which fall in the 24 assessment zones located at a radially second inner position of the analyzing areas 52. The replacement selected zones 523 fall in the assessment zones A02, A06, A10, A14, A18, A22, A26, A30 in the upper level 53, the assessment zones B02, B06, B10, B14, B18, B22, B26, B30 in the middle level 54, and the assessment zones C02, C06, C10, C14, C18, C22, C26, C30 in the lower level 55.

Please refer to FIGS. 14B and 14C. As shown, the one-third of the total number of the assessment zones in the radially second inner position is 8, and the finally calculated sum of the assessment values of the replacement selected zones 523 is 6, which is smaller than the one-third of the total number of the assessment zones, i.e. smaller than 8. Therefore, the replacement digital dental implant 7 is determined as an unsuitable object. The replacement digital dental implant 7 and its object type as an unsuitable object will be shown on the electronic device at the same time.

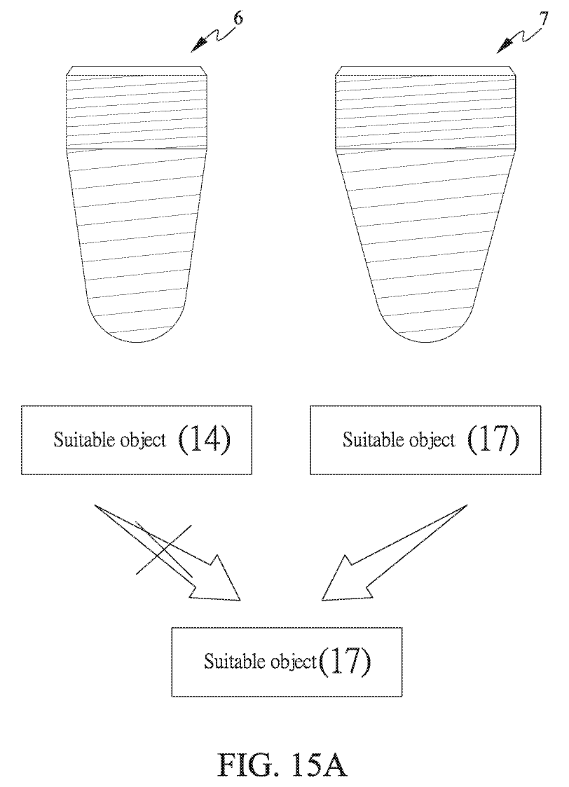

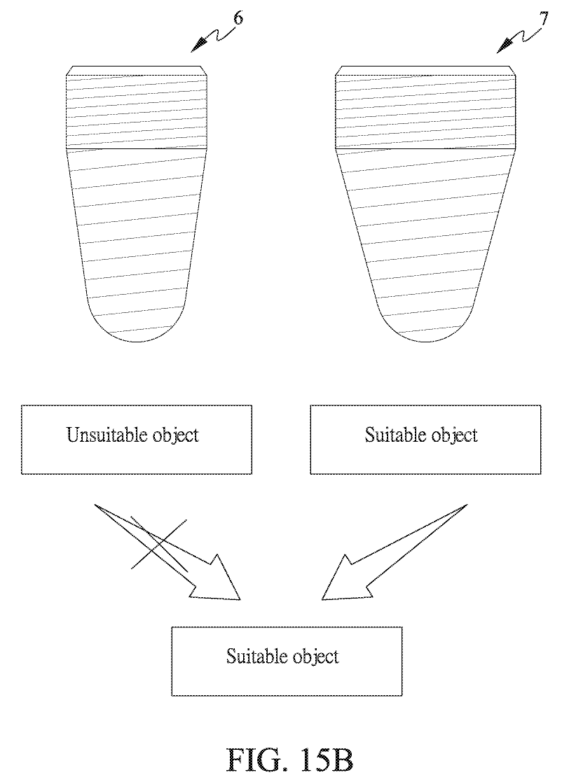

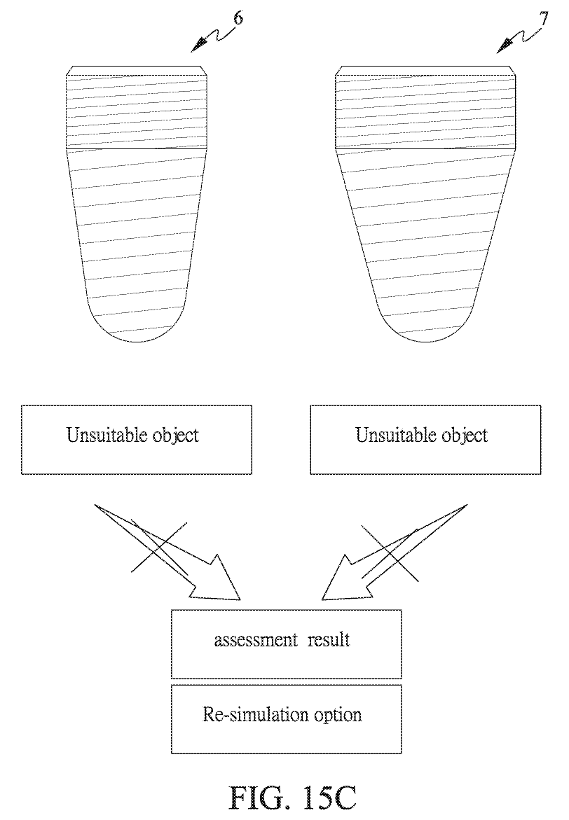

In the option suggesting step S9, the object types of the previous digital dental implant 6 and the replacement digital dental implant 7 are compared to generate a suggested option. Please refer to an example in FIG. 15A. The sum of the assessment values of the digital dental implant 6 is 14, while the sum of the assessment values of the replacement digital dental implant 7 is 17. When both of the digital dental implant 6 and the replacement digital dental implant 7 are suitable objects, the one having a higher sum of the assessment values shall be selected as the suggested option for use in the dental implant surgery. In the illustrated case, the replacement digital dental implant 7 is selected as the suggested option for the dental implant surgery.

Please refer to FIG. 15B. When one of the digital dental implant 6 and the replacement digital dental implant 7 is determined as a suitable object while the other one is an unsuitable object, the comparison of the sums of the assessment values can be omitted and the one model being the suitable object is directly selected as the suggested option for use in the dental implant surgery.

Please refer to FIG. 15C. When the digital dental implant 6 and the replacement digital dental implant 7 all are unsuitable objects, the suggested option includes an assessment result that no dental implant surgery can be performed and a re-simulation option that a re-simulation and assessment step S10 is to be performed.

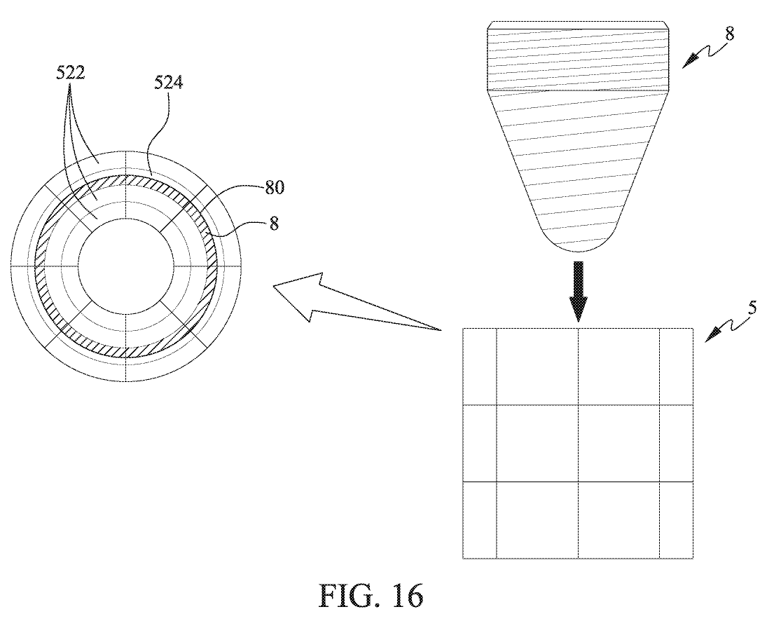

Please refer to FIG. 16. In the re-simulation and assessment step S10, a further replacement digital dental implant 8 is used in place of the replacement digital dental implant 7. The further replacement digital dental implant 8 is dimensionally larger than the replacement digital dental implant 7 and has a further replacement outer peripheral surface 80, which is in contact with the analyzing areas 52 to define a plurality of further replacement selected zones 524. As shown, the further replacement outer peripheral surface 80 defines total 24 further replacement selected zones 524, which fall in the 24 assessment zones located at a radially third inner position of the analyzing areas 52. The further replacement selected zones 524 fall in the assessment zones A03, A07, A11, A15, A19, A23, A27, A31 in the upper level 53, the assessment zones B03, B07, B11, B15, B19, B23, B27, B31 in the middle level 54, and the assessment zones C03, C07, C11, C15, C19, C23, C27, C31 in the lower level 55. Lastly, the sum of the assessment values of the further replacement selected zones 524 is derived and used to determine the object type of the further replacement digital dental implant 8.

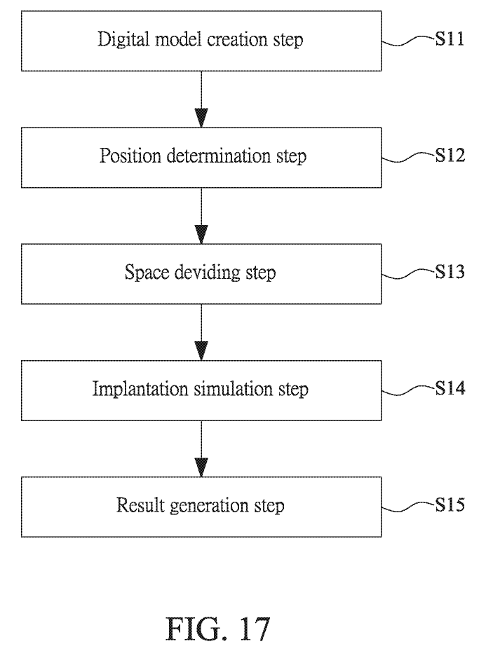

Please refer to FIG. 17. In a third preferred embodiment of the present invention, the dental implantation assessment method comprises a digital model creation step S11, a position determination step S12, a space dividing step S13, an implantation simulation step S14, and a result generation step S15.

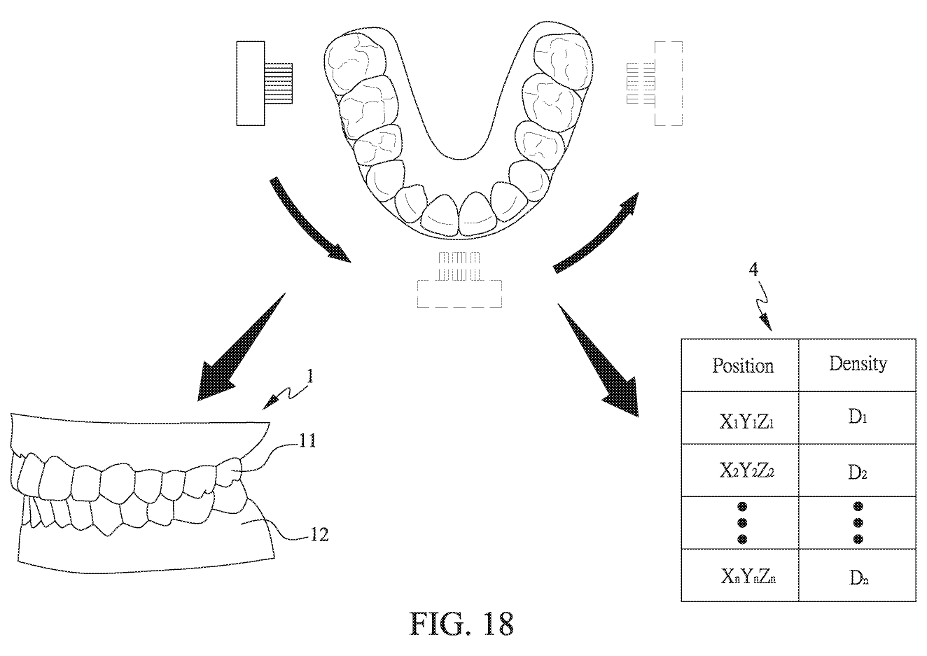

Please refer to FIG. 18. In the digital model creation step S11, a computed tomography (CT) device is used to scan a patient’s oral areas to construct a digital oral model 1 and a model database, the digital oral model 1 includes a plurality of tooth models 11 and an alveolar bone model 12, the model database stores a plurality of position data and a plurality of density data as a healthy status table 4, and the position data and the density data match each position of the alveolar bone model 12.

Please refer to FIG. 5. In the position determination step S12, an electronic device receives the digital oral model 1 to display the tooth models 11 and the alveolar bone model 12, the electronic device selects an objective tooth of the tooth models 11 to construct a reference line 2 matching a centric occlusion of the objective tooth 11, and constructs an implantation space model 5 based on the reference line 2 to encircle the alveolar bone model 12.

Please refer to FIG. 6. In the space dividing step S13, in which the electronic device divides the implantation space model 5 into a plurality of layers 50, the layers include a center area 51 and a plurality of analyzing areas 52 located immediately around the center area 51, and the analyzing areas 52 are divided into a plurality of assessment zones.

Please refer to FIG. 10A and 10B. In the implantation simulation step S14, the electronic device selects a digital dental implant 6 to place in the implantation space model 5, such that the digital dental implant 6 overlaps the center area 51 of layers 50, and one of the assessment zones adjacent to an outer peripheral surface of the digital dental implant 6 is defined as a selected zone 521; and

Please refer to FIGS. 11A to 11C. In the result generation step S15, in which the electronic device receives a plurality of objective density data matching the selected zone 521 of the analyzing areas 52 from the model database, and compares each objective density data with a density threshold value to determine an assessment value of the selected zone 521; the electronic device compares a sum of the assessment values with a threshold value (i.e. 8) to determine an object type of the digital dental implant 6, the digital dental implant 6 being determined as a suitable object allowed for use in immediate implant placement when the sum is larger than the threshold value; and the digital dental implant 6 being determined as an unsuitable object failing to provide stable and firm fixing ability when the sum is smaller than the threshold value.

What is claimed is:

1. A dental implantation assessment method for implant dentistry, comprising:
a digital model creation step, in which a computed tomography (CT) device is used to scan a patient’s oral areas to construct a digital oral model and a model database, the digital oral model includes a plurality of tooth models and an alveolar bone model, the model database stores a plurality of position data and a plurality of density data as a healthy status table, and the position data and the density data match each position of the alveolar bone model;
a position determination step, in which an electronic device receives the digital oral model to display the tooth models and the alveolar bone model, the electronic device selects an objective tooth of the tooth models to construct a reference line matching a centric occlusion of the objective tooth, and constructs an implantation space model based on the reference line to encircle the alveolar bone model;
a space dividing step, in which the electronic device divides the implantation space model into a plurality of layers, the layers include a center area and a plurality of analyzing areas located immediately around the center area, and the analyzing areas are divided into a plurality of assessment zones;
an implantation simulation step, in which the electronic device selects a digital dental implant to place in the implantation space model, such that the digital dental implant overlaps the center area of layers, and one of the assessment zones adjacent to an outer peripheral surface of the digital dental implant is defined as a selected zone; and
a result generation step, in which the electronic device receives a plurality of objective density data matching the selected zone of the analyzing areas from the model database, and compares each objective density data with a density threshold value to determine an assessment value of the selected zone; the electronic device compares a sum of the assessment values with a threshold value to determine an object type of the digital dental implant, the digital dental implant being determined as a suitable object allowed for use in immediate implant placement when the sum is larger than the threshold value; and the digital dental implant being determined as an unsuitable object failing to provide stable and firm fixing ability when the sum is smaller than the threshold value.

2. The dental implantation assessment method for implant dentistry as claimed in claim 1, further comprising a further simulation and assessment step, in which a replacement digital dental implant is used on the electronic device in place of the digital dental implant; the replacement digital dental implant being different from the digital dental implant in size and having a replacement outer peripheral surface; one of the assessment zones adjacent to the replacement outer peripheral surface is defined by the electronic device as a replacement selected zone, and the electronic device determines an object type of the replacement digital dental implant according to the replacement selected zone on the analyzing areas.

3. The dental implantation assessment method for implant dentistry as claimed in claim 2, further comprising an option suggesting step, in which the electronic device compares the object type between the digital dental implant and the replacement digital dental implant to generate a suggested option.

4. The dental implantation assessment method for implant dentistry as claimed in claim 3, wherein, when the digital dental implant and the replacement digital dental implant are determined as suitable objects, one of the suitable objects having a higher sum of the assessment values is selected as the suggested option for use in the dental implant surgery; and when one of the digital dental implant and the replacement digital dental implant is determined as a suitable object while the other one is an unsuitable object, the electronic device selects the suitable object as the suggested option.

5. The dental implantation assessment method for implant dentistry as claimed in claim 3, wherein, when both of the digital dental implant and the replacement digital dental implant are determined as unsuitable objects, the electronic device generates an assessment result that no dental implant surgery can be performed, and suggests a re-simulation and assessment step as the suggested option.

6. The dental implantation assessment method for implant dentistry as claimed in claim 5, wherein, in the re-simulation and assessment step, a further replacement digital dental implant is used on the electronic device in place of the replacement digital dental implant; the further replacement digital dental implant being different from the replacement digital dental implant in size and having a further replacement outer peripheral surface; one of the assessment zones adjacent to the further replacement outer peripheral surface is defined by the electronic device as a further replacement selected zone, so that the electronic device determines an object type of the further replacement digital dental implant according to the further replacement selected zone on the analyzing areas.

7. The dental implantation assessment method for implant dentistry as claimed in claim 1, wherein a diameter of the implantation space model is smaller than a width of the alveolar bone model.

8. The dental implantation assessment method for implant dentistry as claimed in claim 7, wherein an implant diameter of the digital dental implant is limited by the diameter of the implantation space model, and an implant length of the digital dental implant is limited by a layer number of the implantation space mode.

9. The dental implantation assessment method for implant dentistry as claimed in claim 1, wherein a diameter of the implantation space model is smaller than a distance between two teeth located immediately at two lateral sides.
